(19) United States
(12) Patent Application Publication
(10) Pub. No.: US 2019/0135011 A1
(43) Pub. Date: May 9, 2019

(54) QUIET ZONE FOR DIGITAL CODE PATTERN ON A RUBBER ARTICLE

(71) Applicants: The Goodyear Tire & Rubber Company, Akron, OH (US); 4Jet Technologies GmbH, Alsdorf (DE)

(72) Inventors: Baudouin Duchene, Bastogne (BE); Jean-Pierre Noel, Attert (BE); Lucien Biferi, Brehain-La-Ville (FR); Armin Kraus, Herzogenrath (DE)

(21) Appl. No.: 15/802,649

(22) Filed: Nov. 3, 2017

(51) Int. Cl. B41M 5/00; B29C 33/42

(52) U.S. Cl. CPC B41M 5/0064; B60C 13/001; B29C 33/424; B41M 5/0082

(57) ABSTRACT

A rubber article, such as a tire, bearing a digital code pattern is provided. The rubber article includes a quiet zone that surrounds the digital code pattern. The quiet zone is free of surface features in order to provide enhanced acquisition of the digital code pattern. A marking symbol is formed on the rubber article adjacent the quiet zone to provide identification of the quiet zone. A frame is optionally formed on the rubber article adjacent the quiet zone and the marking symbol to delineate the quiet zone.

### FIELD OF THE INVENTION

The invention relates to the marking of rubber articles such as tires. More particularly, the invention relates to the marking of rubber articles with two-dimensional digital code patterns. Specifically, the invention is directed to a structure formed on a rubber article such as a tire that enables optimum placement of a two-dimensional digital code pattern for favorable acquisition or reading of the code.

### BACKGROUND OF THE INVENTION

In order to provide identification and other information for rubber articles such as tires, it is known in the art to mark the sidewall of a tire with a two-dimensional digital code pattern that is readable with an optical scanner. Such two-dimensional digital code patterns include Quick Response (“QR”) codes, DataMatrix (“DM”) codes and the like. For the purpose of convenience, these two-dimensional digital code patterns shall be referred to herein as codes.

The code is encoded with data that is used to identify the tire, for example, the tire model, manufacturing data and/or selected tire characteristics. The code is applied to at least one of the tire sidewalls by processes known to those skilled in the art, such as laser engraving, molding, milling, stickers, and the like. In this manner, information that is used to identify the tire and/or its characteristics is marked or placed on the tire sidewall, thereby enabling easy retrieval of the information by a scanning device. Such scanning devices include automatic scanning devices and hand-held scanning devices, such as hand-held readers and smartphones.

In the prior art, an issue that has arisen with codes on articles such as tires is a lack of optimum placement of the code on the tire sidewall. More particularly, in order for the code to be properly scanned by an automatic or hand-held scanner, it is desirable for the code to be disposed in an optimum location on the tire sidewall.

Increasing the challenge for such optimum placement of the code is the application of the code in mass production. Because there may be slight differences in the positioning of tires when the code is applied to each tire on a manufacturing line, it is possible for the code to be applied slightly outside of an optimum location. For example, due to tolerances within manufacturing equipment and/or human-operated processes, a code may be applied to the tire sidewall in a position that is slightly too far towards the tread of the tire, or slightly too far towards the bead of the tire, to enable optimum scanning of the code. In the event that this occurs, there may be difficulty in scanning the code when the tire is on a vehicle.

Such challenges are compounded for low-profile tires, as these tires have a reduced sidewall height. With a reduced sidewall height, there is a smaller area in which a code may be applied for optimum readability.

An additional consideration is the nature of the sidewall of the tire. That is, the tire sidewall traditionally includes many markings and indicia, as well as certain surface features and/or textures, which may interfere with the ability of a scanner to read the code with optimum precision.

As a result, it is desirable to provide a structure on a rubber article such as a tire that enables optimum placement of a code which in turn provides favorable acquisition or reading of the code.

### SUMMARY OF THE INVENTION

According to an aspect of an exemplary embodiment of the invention, a rubber article bears a digital code pattern. The article includes a quiet zone that surrounds the digital code pattern and is free of surface features. A marking symbol is formed on the rubber article adjacent the quiet zone to indicate the quiet zone.

### BRIEF DESCRIPTION OF THE DRAWINGS

The invention will be described by way of example and with reference to the accompanying drawings, in which:

FIG. 1 is a fragmentary elevational view of a portion of a tire sidewall that includes an exemplary embodiment of a quiet zone, marker and frame of the present invention;

FIG. 2 is a view of the invention shown in FIG. 1 with an exemplary code formed on the tire sidewall;

FIG. 3 is an enlarged elevational view of an exemplary embodiment of a marker and a portion of a frame of the invention;

FIG. 4 is an enlarged elevational view of another exemplary embodiment of a quiet zone, marker and frame of the invention; and

FIG. 5 is a schematic representation of alternate configurations of the marker and frame of the invention.

Similar numerals refer to similar parts throughout the drawings.

### DETAILED DESCRIPTION OF THE INVENTION

It is to be understood that the term radial direction refers to the direction that extends perpendicular to the axis of rotation to the tire, and that the term circumferential direction refers to the direction that extends parallel to the direction of rotation of the tire.

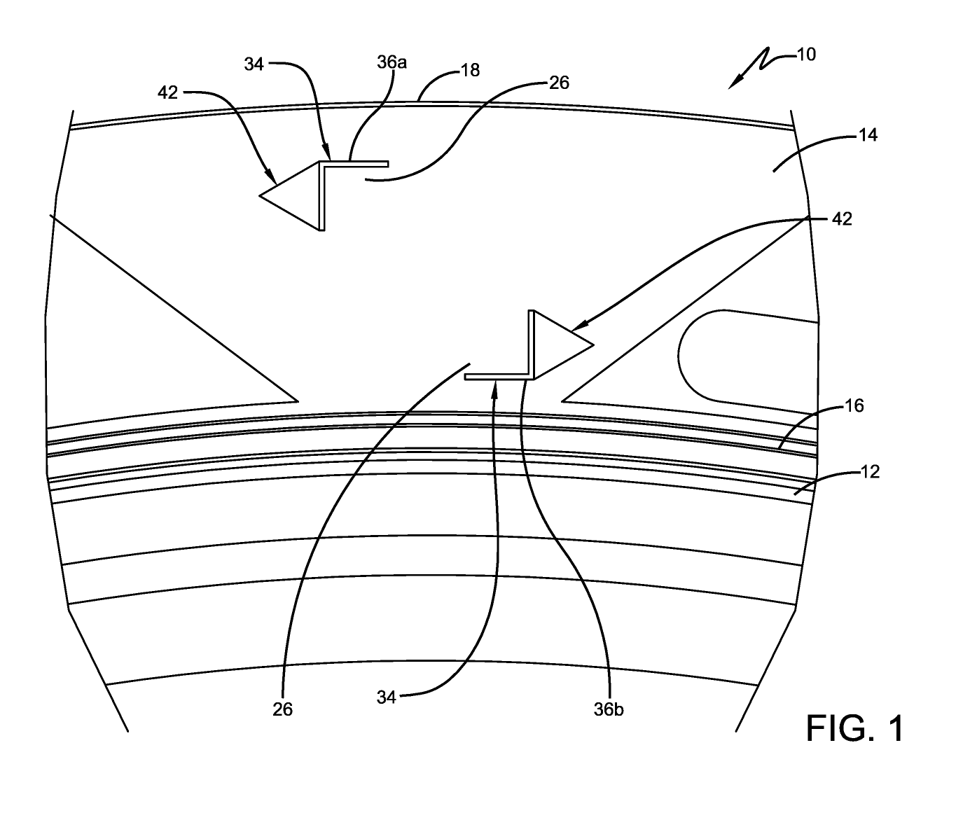

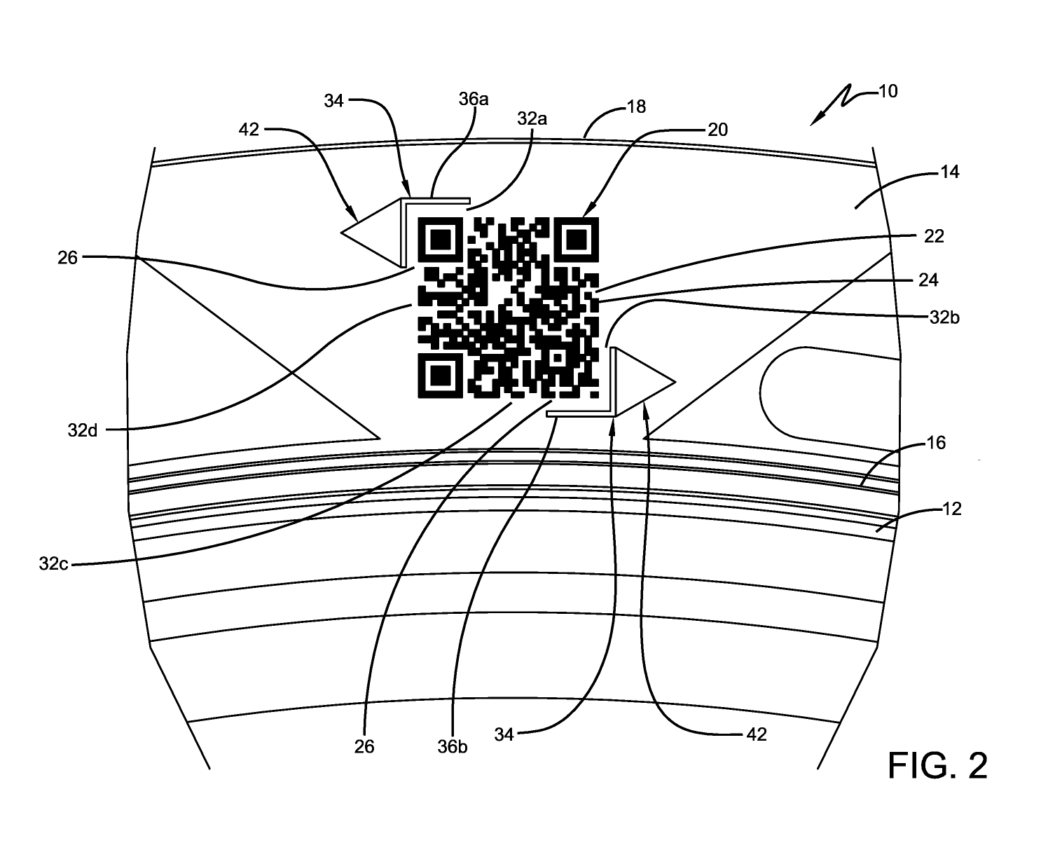

Turning to FIGS. 1 and 2, an exemplary rubber article, such as a tire 10, is mounted on a rim 12 in a conventional manner as known to those skilled in the art. The tire 10 includes a pair of sidewalls 14 (only one shown) extending from respective bead areas 16 (only one shown) to a tread 18. In order to provide information such as tire identification and/or other characteristics, it is known in the art to mark the tire sidewall 14 with a two-dimensional digital code pattern 20 such as a QR code, a DM code and the like. As mentioned above, for the purpose of convenience, these two-dimensional digital code patterns shall be referred to herein as codes 20.

As shown in FIG. 2 and known to those skilled in the art, the code 20 is comprised of light modules 22 and dark modules 24. The light modules 22 include a high optical reflectivity and the dark modules 24 include a low optical reflectivity. For example, nominal optical reflectivity for the light modules 22 is preferred to be at least fifty percent (50%) higher than the nominal optical reflectivity for the dark modules 24. It is to be understood that the term “optical reflectivity” includes a reflectivity as known in the art for at least one of infrared radiation, visible light, ultraviolet radiation, and the like.

The code 20 is applied to or formed in the tire sidewall 14 radially outwardly of the bead area 16 and radially inwardly of the tread 18. The specific location of the code 20 depends on particular design considerations, such as the size of the tire 10, the size of the code that is to be employed, the height of the tire sidewall 14, how the code is to be formed, and the like.

In order for the code 20 to be acquired or read properly by a scanner, it is preferable for a quiet zone 26 to be formed about the code. Preferably, the quiet zone 26 includes interconnected sides 32a, 32b, 32c, 32d that surround the code 20. In this manner, the quiet zone 26 completely surrounds the code 20 and is an area on the tire sidewall 14 that is free of markings, indicia and/or other features, which are collectively referred to herein as surface features, thereby enabling a scanner (not shown) to readily focus on the code 20. By enabling the scanner to focus on the code 20 rather than other features, the quiet zone 26 optimizes the ability of the scanner to read and acquire the code.

The size and shape of the quiet zone 26 depends upon the size and shape of the code 20, as well as the type of code that is employed. More particularly, as mentioned above, each code 20 is formed with light modules 22 and dark modules 24, which are arranged in specific configurations as known to those skilled in the art. When the code 20 is a QR code, the modules 22 and 24 tend to be smaller than when the code is a DM code, as known in the art. Thus, when the code 20 is a QR code, each side 32a, 32b, 32c and 32d of the quiet zone 26 includes a width that is at least four times as wide as one dark module 24. When the code 20 is a DM code, each side 32a, 32b, 32c and 32d of the quiet zone 26 includes a width that is at least the same width as one dark module 24. In order to enable scanners to readily distinguish the quiet zone 26 from the code 20, the quiet zone preferably includes a nominal reflectance value or nominal optical reflectivity that is equal to that of the light modules 22.

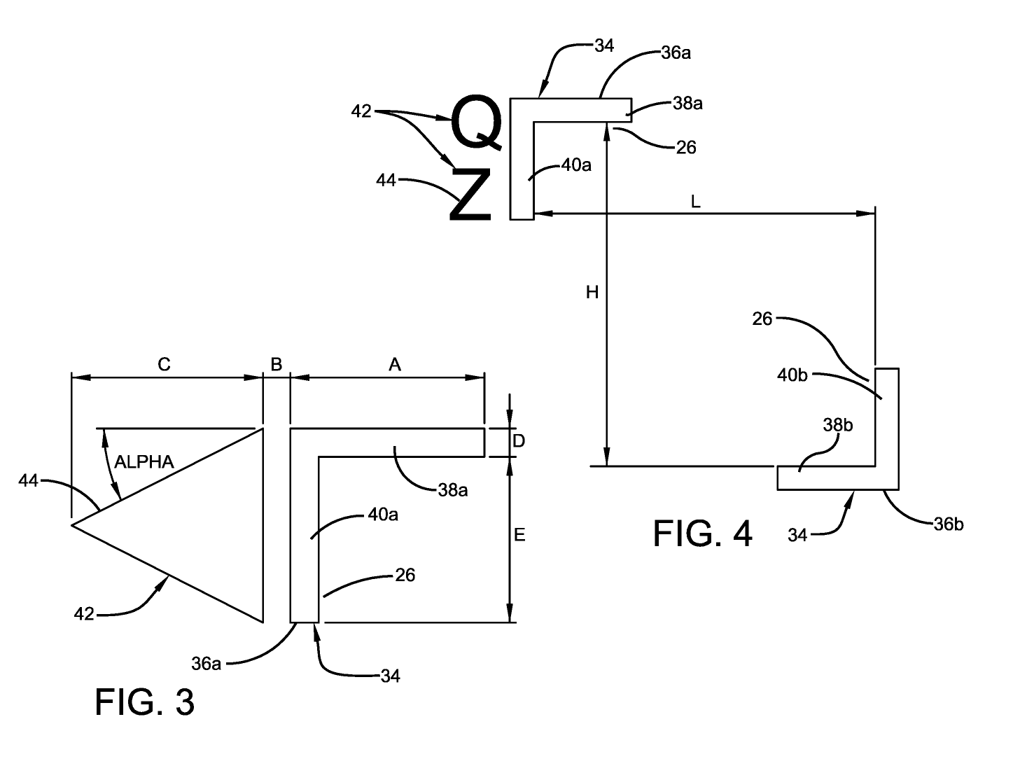

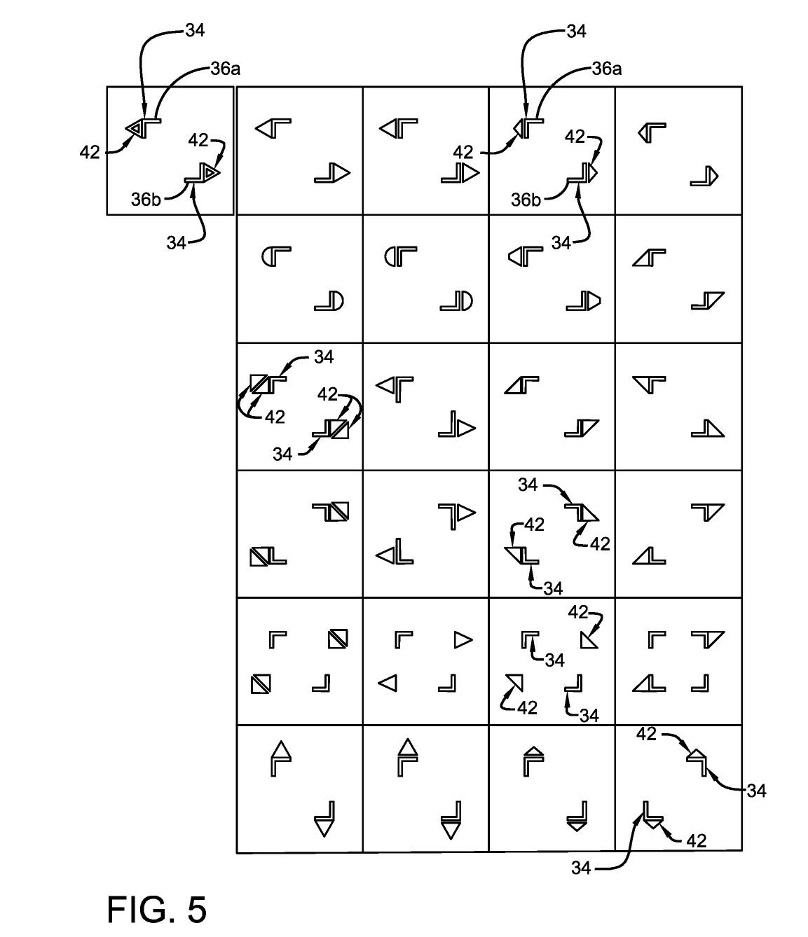

In order to delineate and thus secure the quiet zone 26, a physical frame 34 preferably is formed on the tire sidewall 14 about the quiet zone. The frame 34 includes geometric features that mark at least two corners 36a and 36b surrounding the quiet zone 26, which thereby designate the area of the quiet zone. Of course, more than two corners of the quiet zone 26 may be marked by the frame 34, as the frame may mark three corners, four corners and/or the entire perimeter of the quiet zone. Moreover, as shown in FIG. 5, the frame 34 may be formed of any convenient geometric shape that accurately designates the quiet zone 26, such as complete lines that form a square, rectangle or other polygon, or partial lines that form an angle, side and/or corner marking. In addition, the frame may be formed of solid geometric shapes or outlines thereof. For example, turning to FIGS. 2 and 3, the frame 34 may include a first corner marking 36a and an opposing corner marking 36b, each one of which in turn includes a circumferentially-extending leg 38a, 38b, respectively, and a radially-extending leg 40a, 40b, respectively. In this manner, the frame 34 surrounds and thus clearly sets or designates the external boundary or limit of the quiet zone 26.

To enhance recognition of the quiet zone 26 and the location of the code 20, which serves to amplify the acquisition of the code, a marking symbol, referred to herein as a marker 42, preferably is formed on the tire sidewall 14 adjacent the frame 34. By being formed adjacent the frame 34, the marker 42 is also adjacent the quiet zone 26. If a frame 34 is not employed, the marker 42 may be formed directly adjacent the quiet zone 26 to indicate the quiet zone. As shown in FIGS. 4 and 5, the marker 42 may be any convenient and clear symbol, including letters, words, geometric markings or combinations thereof, as well as solid shapes or characters or outlines thereof. For example, the marker 42 may include the letters QZ to indicate the quiet zone area, QR when a QR code is employed, or DM when a DM code is employed.

Referring now to FIGS. 1 through 3, the marker 42 preferably is formed with at least one edge, which shall be referred to herein as an angled edge 44, which is not parallel to the circumferential direction of the tire 10, nor parallel to the radial direction of the tire. Edges of the marker 42 that are parallel to the circumferential direction of the tire 10 or parallel to the radial direction of the tire may be difficult for equipment such as a light sensor to recognize due to the orientation of the sensor. Therefore, the marker 42 preferably is formed with at least one angled edge 44, which is at an angle Alpha that is between about 10 degrees and about 80 degrees relative to the circumferential direction of the tire 10, and between about 10 degrees and about 80 degrees relative to the radial direction of the tire. More preferably, the angle Alpha of the angled edge 44 is about 45 degrees relative to the circumferential direction of the tire 10 and about 45 degrees relative to the radial direction of the tire. Of course, the marker 42 may include multiple angled edges 44, depending on design considerations.

The size of the marker 42 depends on the resolution of the sensor that is employed to read it. For most sensors, it is preferred that the marker 42 be at least 2 millimeters (mm) wide, that is, 2 mm in the circumferential direction, and least 2 mm high, that is, 2 mm in the radial direction. More preferably, the marker 42 is at least 4 mm wide, that is, 4 mm in the circumferential direction, and least 4 mm high, that is, 4 mm in the radial direction.

The frame 34 and the marker 42 may be formed in a number of ways. For example, they may be molded or etched into the tire sidewall 14 and thus recessed into the sidewall surface, or molded or formed on the tire sidewall to protrude outboardly past the sidewall surface. The depth of the etch of the frame 34 and the marker 42 or the height of the protrusion of the frame and the marker depends on the resolution of the sensor reading the marker. For example, a sheet of light sensor, also known as a light sensor, may be employed to detect the marker 42. Many such sensors have a depth resolution of about 10 to 20 micrometers, so any depth of an etch or height of a protrusion for the frame 34 and the marker 42 that is greater than this resolution would be sufficient. For optimum performance, a depth of an etch or height of a protrusion for the frame 34 and the marker 42 that is significantly greater than the sensor resolution, such as at least 100 micrometers or 0.1 mm is preferred, and at least 200 micrometers or 0.2 mm is more preferred.

Turning to FIGS. 3 and 4, exemplary sizes and dimensions of the frame 34 and the marker 42 are shown. As indicated, the letter A is the circumferential length of a selected corner 36a of the frame 34, which preferably is from about 5 mm to about 10 mm; B is the distance in the circumferential direction between the frame 34 and the marker 42, which preferably is from about 0 mm to about 5 mm; C is the circumferential length of the marker 42, which preferably is from about 3 mm to about 10 mm; D is the thickness or width in the radial direction of the circumferential leg 38a of the frame corner 36a, which is preferably from about 0.5 mm to about 3 mm; E is the radial length of the radial leg 40a of the frame corner 36a up to the circumferential leg 38a of the frame corner, which preferably is from about 3 mm to about 10 mm.

The letter H indicates the radial height between the corners 36a and 36b of the frame 34, which defines the radial height of the quiet zone 26, and is therefore dependent upon the dimensions of the code 20 (FIG. 2). For a QR code 20, the minimum value for H is the radial height of the QR code plus 8 times the height of a dark module 24. For a DM code 20, the minimum value for H is the radial height of the QR code plus 2 times the height of a dark module 24. The letter L is the circumferential length between the corners 36a and 36b of the frame 34, which defines the circumferential length of the quiet zone 26, and is therefore dependent upon the dimensions of the code 20. For a QR code 20, the minimum value for L is the circumferential length of the QR code plus 8 times the height of a dark module 24. For a DM code 20, the minimum value for H is the circumferential length of the QR code plus 2 times the height of a dark module 24. Angle Alpha is the angle of edge 44 extending in a radial direction relative to the circumferential direction of the tire 10. As mentioned above, Alpha preferably is between about 10 degrees and about 80 degrees relative to the circumferential direction of the tire 10, and more preferably about 45 degrees relative to the circumferential direction of the tire.

By way of further example, when the code 20 is a QR code that is about 16.25 mm in the circumferential direction by about 16.25 mm in the radial direction: A is about 7 mm; B is about 0 mm; C is about 7 mm; D+E is about 7 mm; H is about 22 mm; and L is about 22 mm. Such dimensions yield a quiet zone 26 of from about 2.8 mm to about 2.9 mm on all sides 32a, 32b, 32c, 32d. In many cases, H and L for a code 20 that is a QR code are each from about 21 mm to about 22 mm, and about 14 mm to about 15 mm for DM code. In this manner, it is preferred that the quiet zone 26 be at least 2 mm wide on each side 32a, 32b, 32c, 32d. This ensures that there is at least 2 mm of distance between the code 20 and the frame 34. Dimensions such as these enable the code 20 to be centered within the quiet zone 26 at a tolerance of plus or minus about 0.5 mm.

In operation, the marker 42, and the frame 42 if employed, are formed on the tire sidewall 14 as described above to designate the quiet zone 26. After the marker 42 is formed, it can be detected with a sensor, such as a sheet of light sensor, a vision system that uses a photograph or video, or other types of automated detection systems known in the art, as well as by visual recognition from a human. Once the marker 42 is detected, the code 20 is applied to the tire sidewall 14 in the center of the quiet zone 26, as denoted by the frame 34 if the frame is employed, thereby assuring that the quiet zone surrounds the code. The code 20 may be applied to the sidewall 14 by any means known in the art, including laser engraving, molding, milling, stickers, and the like.

In this manner, the code 20 is surrounded by the quiet zone 26. The quiet zone 26 is defined by the frame 34, and the quiet zone and frame are denoted by the marker 42. Such placement of the code 20 ensures that a sufficient quiet zone 26 surrounds the code, thereby enabling optimum acquisition or reading of the code when it is scanned.

The invention also provides for the use of two or more quiet zones 26 on a tire sidewall 14, each of which is indicated by a respective marker 42 and optionally denoted by a respective frame 34. The code 20 may be applied to only of the quiet zones 26, depending on design considerations. The use of multiple quiet zones 26 may prevent a potential conflict of the code 20 with a balance mark or other optically reflective or color marking on the tire 10, which may impair the code and/or reduce readability of the code.

The present invention also includes a method of forming and/or using a quiet zone 26 and/or frame 34 about a code 20, as well as a method of forming and/or using a marker 42 to designate a frame 34 and/or quiet zone 26 about a code 20. Each method includes steps in accordance with the description that is presented above and shown in FIGS. 1 through 5.

As is known to those skilled in the art, tire sidewalls 14 are made of rubber. As a result, the invention applies to any article made of rubber, with tires 10 being provided as an example herein. In addition, while the code 20 has been described with reference to two-dimensional digital code patterns that include Quick Response (“QR”) codes and DataMatrix (“DM”) codes, other digital code patterns may be employed without affecting the overall concept or operation of the invention.

It is to be understood that the structure of the above-described quiet zone 26, frame 34 and marker 42 may be altered or rearranged, or components known to those skilled in the art omitted or added, without affecting the overall concept or operation of the invention. The invention has been described with reference to preferred embodiments. Potential modifications and alterations will occur to others upon a reading and understanding of this description. It is to be understood that all such modifications and alterations are included in the scope of the invention as set forth in the appended claims, or the equivalents thereof.

What is claimed is:

1. A rubber article bearing a digital code pattern, the article comprising:
a quiet zone surrounding the digital code pattern, the quiet zone being free of surface features; and
a marking symbol formed on the rubber article adjacent the quiet zone to indicate the quiet zone.

2. The rubber article bearing a digital code pattern of claim 1, wherein the two-dimensional digital code pattern includes at least one of a Quick Response code and a DataMatrix code.

3. The rubber article bearing a digital code pattern of claim 1, wherein the quiet zone includes sides surrounding the digital code pattern, each one of the sides being at least 2 mm wide.

4. The rubber article bearing a digital code pattern of claim 1, wherein the digital code pattern is formed with dark modules including a low optical reflectivity and light modules including a high optical reflectivity, the quiet zone includes sides surrounding the digital code pattern, and each side of the quiet zone includes a width that is at least the same width as a dark module of the digital code pattern.

5. The rubber article bearing a digital code pattern of claim 4, wherein each side of the quiet zone includes a width that is at least four times as wide as a dark module of the digital code pattern.

6. The rubber article bearing a digital code pattern of claim 4, wherein the quiet zone includes a nominal reflectance value that is equal to that of the light modules of the digital code pattern.

7. The rubber article bearing a digital code pattern of claim 1, wherein the rubber article includes a tire that in turn includes a pair of sidewalls, and the digital code pattern, quiet zone and marking symbol are formed on one of the sidewalls.

8. The rubber article bearing a digital code pattern of claim 7, wherein the marking symbol is formed with at least one angled edge, the at least one angled edge being between about 10 degrees and about 80 degrees relative to a circumferential direction of the tire and between about 10 degrees and about 80 degrees relative to a radial direction of the tire.

9. The rubber article bearing a digital code pattern of claim 8, wherein the at least one angled edge is about 45 degrees relative to the circumferential direction of the tire and about 45 degrees relative to the radial direction of the tire.

10. The rubber article bearing a digital code pattern of claim 7, wherein the marking symbol is at least 2 mm wide in a circumferential direction of the tire and at least 2 mm in a radial direction of the tire.

11. The rubber article bearing a digital code pattern of claim 7, wherein the marking symbol is formed in the tire sidewall at a depth of at least 0.1 mm.

12. The rubber article bearing a digital code pattern of claim 11, wherein the marking symbol is formed in the tire sidewall at a depth of at least 0.2 mm.

13. The rubber article bearing a digital code pattern of claim 7, wherein the marking symbol is formed on the surface of the tire sidewall at a height of about 0.1 mm.

14. The rubber article bearing a digital code pattern of claim 13, wherein the marking symbol is formed on the surface of the tire sidewall at a height of about 0.2 mm.

15. The rubber article bearing a digital code pattern of claim 1, further comprising more than one quiet zone on the rubber article.

16. The rubber article bearing a digital code pattern of claim 15, wherein a respective marking symbol is formed adjacent each quiet zone.

17. The rubber article bearing a digital code pattern of claim 15, wherein only one of the quiet zones surrounds the digital code pattern.

18. The rubber article bearing a digital code pattern of claim 1, further comprising a frame formed on the rubber article about at least a portion of the quiet zone, wherein the marking symbol is adjacent the quiet zone and the frame.

19. The rubber article bearing a digital code pattern of claim 18, wherein the frame includes geometric features that mark at least two corners surrounding the quiet zone.

20. The rubber article bearing a digital code pattern of claim 18, wherein:
the rubber article includes a tire that in turn includes a pair of sidewalls;
the frame is formed on one of the sidewalls; and
the frame includes a first corner marking and an opposing corner marking, each one of which includes a circumferentially-extending leg and a radially-extending leg.
